(19) United States
(12) Patent Application Publication
(10) Pub. No.: US 2024/0090538 A1
(43) Pub. Date: Mar. 21, 2024

(54) THAWING DEVICE AND THAWING METHOD

(71) Applicant: Sodick Co., Ltd., Kanagawa (JP)

(72) Inventors: Takeshi OKIYAMA, Kanagawa (JP); Takuya TANIGUCHI, Kanagawa (JP); Akinori NOGUCHI, Kanagawa (JP)

(73) Assignee: Sodick Co., Ltd., Kanagawa (JP)

(21) Appl. No.: 18/453,328

(22) Filed: Aug. 22, 2023

(30) Foreign Application Priority Data
Sep. 15, 2022 (JP) 2022-146687

(51) Int. Cl. A23L 3/365; A47J 36/24

(52) U.S. Cl. CPC A23L 3/365; A47J 36/2483

(57) ABSTRACT

The invention provides a thawing device including a power and a pair of electrodes connected with the power, and thawing a frozen food disposed between the pair of electrodes through electric heating. The thawing device includes a cooling device configured to cool a temperature of a periphery of the frozen food to a predetermined temperature equal to or higher than a temperature of the frozen food before thawing and equal to or lower than 0° C.

### CROSS-REFERENCE TO RELATED APPLICATION

This application claims the priority benefit of Japan application serial No. 2022-146687, filed on Sep. 15, 2022. The entirety of the above-mentioned patent application is hereby incorporated by reference herein and made a part of this specification.

### BACKGROUND

### Technical Field

The invention relates to a thawing device and a thawing method which thaws a frozen food through electric heating.

### Description of Related Art

In general, it is widely applied that foods are transported and preserved in a frozen state, and the frozen foods are thawed before being processed or eaten. By being frozen, foods can be preserved for a long time while being fresh. Furthermore, recent developments in freezing technology have made it possible to freeze foods in a fresh state. However, in frozen foods such as meat, poultry and seafood in particular, it is known that water containing a flavor component known as drip leaks out at the time of being thawed. The flavor component of the food from which drip leaks is reduced, and the taste of the food deteriorates.

It is known that the drip can be suppressed from occurring by thawing the entire frozen food so that the temperature of the entire frozen food increases as evenly and uniformly as possible. Here, evenly increasing the temperature indicates that, in the middle of thawing a frozen food, the difference between the temperature of a portion of the frozen food and the temperature of portions other than the portion is small. For example, specifically, evenly increasing the temperature indicates that, in the middle of thawing the frozen food, the difference of the temperature of the central portion of the frozen food and the temperature of outer portions other than the central portion is small.

It is known that, in natural thawing, by placing the frozen food in an environment at a temperature higher than 0° C. and lower than 10° C. and slowly increasing the temperature of the frozen food, the frozen food can be thawed evenly and uniformly, and drip can be suppressed from occurring. However, such natural thawing requires a thawing time as long as several hours. To thaw a large chunk of frozen food, it requires an even longer thawing time. In particular, in a food processing factory, although it suffices as long as processed products are produced on schedule, it is also required to cope with additional production that is urgent, and it is hoped to thaw a large chunk of frozen food within a short time.

Among thawing devices capable of thawing the entire frozen food within a thawing time shorter than natural thawing, for example, there are thawing devices using induction heating and thawing devices using electric heating.

In the thawing device using induction heating, in general, the frozen food is irradiated with micro waves to generate friction heat by vibrating water molecules of the frozen food, thereby heating and thawing the frozen food. Examples of thawing devices using micro waves include, for example, a food thawing device disclosed in Patent Document 1 (Japanese Laid-open No. 2005-000053) and a thawing chamber disclosed in Patent Document 2 (Japanese Laid-Open No. 2001-263929).

Micro waves tend to concentrate at protruding portions of the frozen food and may excessively heat the protruding portions. The food thawing device of Patent Document 1 discloses to cool the protruding portions of the frozen food under the irradiation of microwaves by using a cooled gas (referred to as cool air in the following), thereby suppressing an excessive temperature increase in the protruding portions.

In addition, micro waves may attenuate when penetrating into the interior of the frozen food and may not reach a portion deep inside a large chunk of frozen food. If micro waves of high output are adopted, the microwaves can reach a portion deep inside the large chunk of frozen food. However, the microwaves of high output may excessively heat the surface of the frozen food. The thawing chamber of Patent Document 2 discloses that if the output of microwave waves is increased, the excessive temperature increase on the surface of the frozen food irradiated with microwaves is suppressed by cooling the surface by using cool air.

Since the thawing device using induction heating uses microwaves, the device configuration thereof is more complicated and the cost thereof is higher than the thawing device using electric heating. In particular, in the case of large-sized thawing devices for thawing large chunks of frozen foods, the cost difference further increases.

The thawing device using electric heating generally makes use of the electrical resistance exhibited in the frozen food, and directly conducts power to the frozen food by using a pair of electrodes, thereby heating and thawing the frozen food. Electric heating is also referred to as Joule heating. Compared with thawing devices using induction heating, the device configuration of the thawing device using electric heating is simpler, and the cost of the thawing device using electric heating is lower. Regarding the thawing devices using electric heating, for example, Patent Document 3 (Japanese Patent No. H07-241184) discloses a thawing method for frozen fish meat paste, Patent Document 4 (Japanese Laid-open No. 2007-097516) discloses a thawing method and a thawing device for a frozen object, Patent Document 5 (Japanese Patent No. 2975593) discloses a thawing method and a thawing device of frozen fish meat paste, and Patent Document 6 (Japanese Patent No. 2931840) discloses a food heating device and heating method.

Also, in the thawing device using electric heating, the conducted power may be AC power or DC power. However, Patent Documents 3 and 4 disclose that AC power is preferred. This is because the impedance of the electrical resistance in AC power depends on the frequency of the AC power that is provided, and AC power exhibits a property that the higher the frequency, the lower the impedance, and the more easily the current flows. Patent Document 3 discloses to use an AC voltage in which the voltage is 215 V and the frequency is 50 Hz or more and 10 KHz or less, preferably 1 KHz or more and 10 KHz or less. Patent Document 4 discloses to use an AC voltage in which the voltage is 50 V or more and 200 V or less, preferably 60 V or more and 140 V or less, and more preferably 80V or more and 120 V or less, and the frequency is 50 Hz or more and 500 KHz or less, preferably 50 Hz or more and 50 KHz or less.

In addition, in the thawing devices using electric heating, the thawing device of Patent Document 7 (Japanese Patent No. S46-010902), the thawing device of Patent Document 8 (Japanese Patent No. S48-002343) and the cooking device of Patent Document 9 (Japanese Patent No. 5034896) disclose electrodes deformed in accordance with the surface shapes of frozen foods. In addition, the thawing method of frozen foods by conducting power of Patent Document 10 (Japanese Patent No. H07-241185) discloses that, in the thawing device using electric heating, the frozen food is immersed into a liquid that is electrically conductive and has an electrical conductivity equal to or lower than the frozen food in a state of being separated from the electrode, the periphery of the frozen food, including a space between the frozen food and the electrode, is filled with the liquid that is electrically conductive. In addition, the underwater power conduction thawing device of Patent Document 11 (Japanese Patent No. S52-022463) discloses to immerse the frozen food and a wire mesh electrode, in a direct contact state, into a liquid that is electrically conductive. In addition, the frozen food thawing device and electrode plate of Patent Document 12 (Japanese Laid-open No. 2005-065690) disclose to, in the thawing device using electric heating, inject a liquid that is electrically conductive only to a gap provided between the frozen food and the electrode. In addition, Patent Document 13 (Japanese Patent No. S52-013158) discloses to, in the thawing device using electric heating, impregnate an absorptive and flexible sponge with a liquid that is electrically conductive and interpose the sponge between the frozen food and the electrode to be electrically conductive.

Compared with the thawing device using induction heating, the device configuration of the thawing device using electric heating is simpler, and the cost of the thawing device using electric heating can be suppressed.

### PRIOR ART DOCUMENT(S)

### Patent Document(s)

[Patent Document 1] Japanese Laid-open No. 2005-000053
[Patent Document 2] Japanese Laid-open No. 2001-263929
[Patent Document 3] Japanese Patent No. H07-241184
[Patent Document 4] Japanese Laid-open No. 2007-097516
[Patent Document 5] Japanese Patent No. 2975593
[Patent Document 6] Japanese Patent No. 2931840
[Patent Document 7] Japanese Patent No. S46-010902
[Patent Document 8] Japanese Patent No. S48-002343
[Patent Document 9] Japanese Patent No. 5034896
[Patent Document 10] Japanese Patent No. H07-241185
[Patent Document 11] Japanese Patent No. S52-022463
[Patent Document 12] Japanese Laid-open No. 2005-065690
[Patent Document 13] Japanese Patent No. S52-013158

However, in the thawing device using electric heating, for example, when a large chunk of frozen food is thawed in room temperature, the temperature of the surface portion of the frozen food may increase faster than the temperature of the interior, and the temperature of the entire frozen food cannot increase uniformly and evenly. In particular, if the temperature of the entirety of the frozen food, such as meat, poultry or seafood, cannot increase uniformly and evenly, drip may occur.

As a result of repeated research by the Applicant, it is realized that, this is because when the frozen food is placed in an environment at a temperature higher than 0° C., the surface portion of the frozen food is thawed due to the environmental temperature, and the impedance of the surface portion of the frozen food becomes smaller than the impedance of the interior of the frozen food. As a result, a greater amount of current flows through the surface portion whose impedance is smaller than the inside.

### SUMMARY

A thawing device according to the invention includes a power and a pair of electrodes connected with the power. The thawing device thawing a frozen food disposed between the pair of electrodes through electric heating includes a cooling device configured to cool a temperature of a periphery of the frozen food to a predetermined temperature equal to or higher than a temperature of the frozen food before thawing and equal to or lower than 0° C.

According to a thawing method of the invention, in the thawing method of thawing the frozen food F through electric heating, the frozen food F is thawed through electric heating in a state in which the temperature of the periphery of the frozen food F is set to the predetermined temperature equal to or higher than the temperature of the frozen food F before thawing and equal to or lower than 0° C.

### BRIEF DESCRIPTION OF THE DRAWINGS

FIG. 1 is a schematic view illustrating an embodiment of a thawing device of the invention.

FIG. 2 is a schematic cross-sectional view taken along signs of A-A of FIG. 1.

FIG. 3 is a schematic view illustrating another embodiment of a thawing device of the invention.

FIG. 4 is a schematic cross-sectional view taken along signs B-B of FIG. 3.

FIG. 5 is a schematic view illustrating another embodiment of a thawing device of the invention.

FIG. 6 is a schematic cross-sectional view taken along signs C-C of FIG. 5.

FIG. 7 is a schematic view illustrating an embodiment of a thawing device of the invention.

FIG. 8 is a schematic view illustrating another embodiment of a thawing device of the invention.

FIG. 9 is a schematic view illustrating another embodiment of a thawing device of the invention.

FIG. 10 is a schematic cross-sectional view taken along signs D-D of FIG. 9.

FIG. 11 is a schematic view illustrating another embodiment of a thawing device of the invention.

FIG. 12 is a schematic view illustrating another embodiment of a thawing device of the invention.

FIG. 13 is a schematic view illustrating another embodiment of a thawing device of the invention.

FIG. 14 is a schematic view illustrating another embodiment of a thawing device of the invention.

FIG. 15 is a schematic cross-sectional view taken along signs E-E of FIG. 14.

FIG. 16 is a schematic view illustrating another embodiment of a thawing device of the invention.

### DESCRIPTION OF THE EMBODIMENTS

According to the thawing device and thawing method of the invention, the temperature of the entire frozen food is more uniformly and evenly increased in a thawing device and a thawing method using electric heating. Also, according to the thawing device and thawing method of the invention, the temperature of the entire frozen food is more uniformly and evenly increased to further suppress drip from occurring from the frozen food at the time of thawing frozen foods such as meat, poultry or seafood in the thawing device and the thawing method using electric heating.

According to the thawing device and the thawing method of the invention, it is possible to more uniformly and evenly increase the temperature of the entire frozen food in the thawing device and the thawing method using electric heating. In addition, according to the thawing device and the thawing method of the invention, it is possible to more uniformly and evenly increase the temperature of the entire frozen food in the thawing device and the thawing method using electric heating to further suppress drip from occurring from the frozen food at the time of thawing the frozen food such as meat, poultry or seafood.

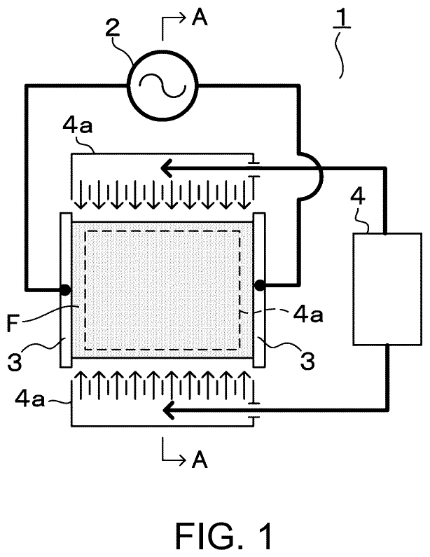

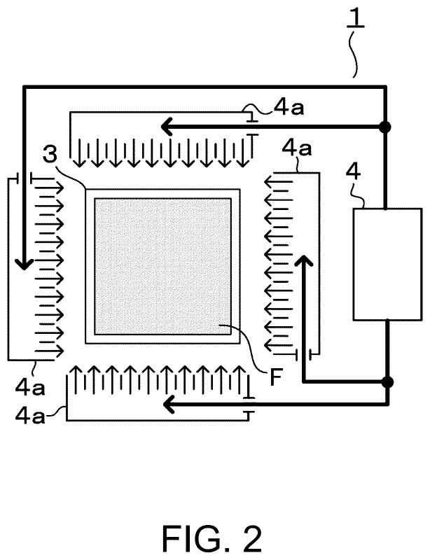

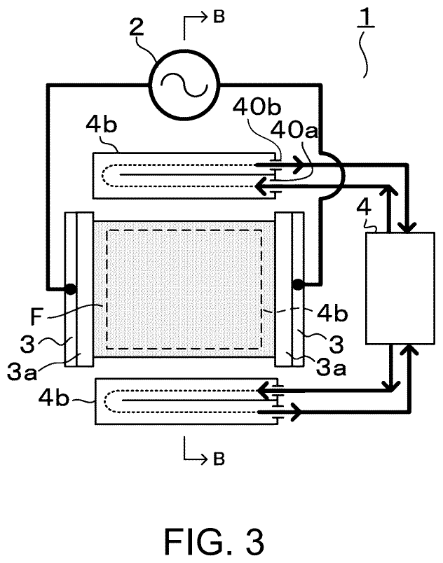

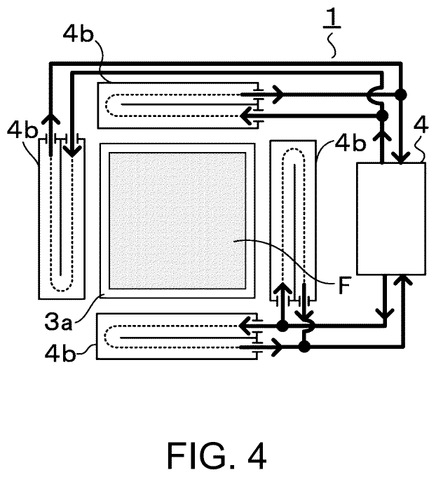

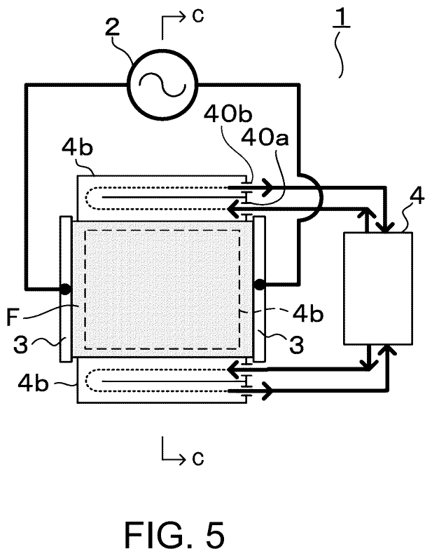

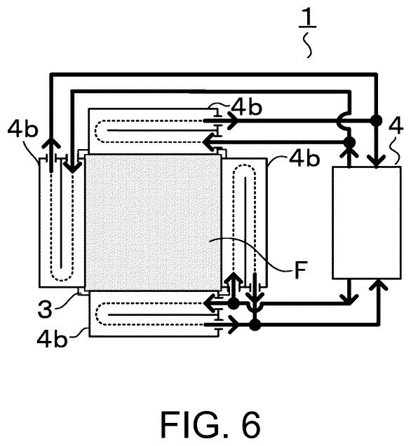

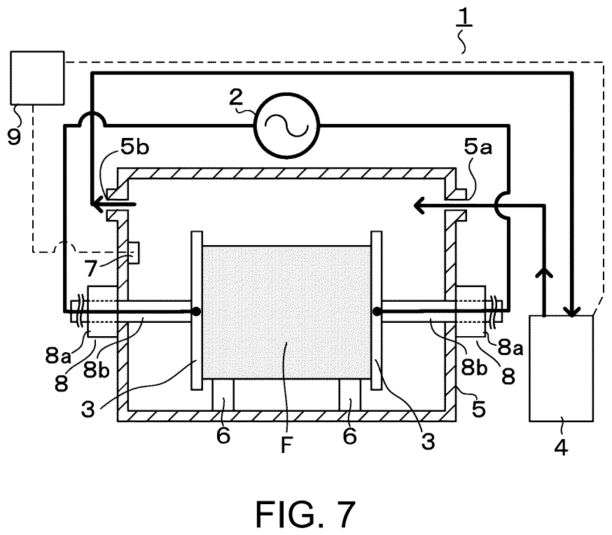

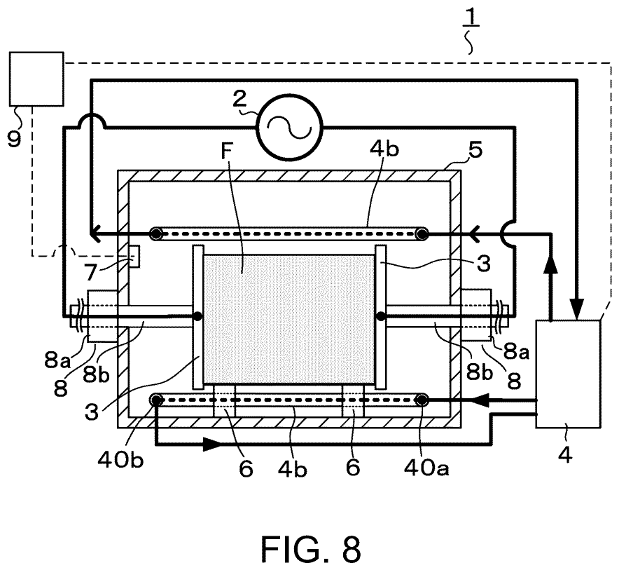

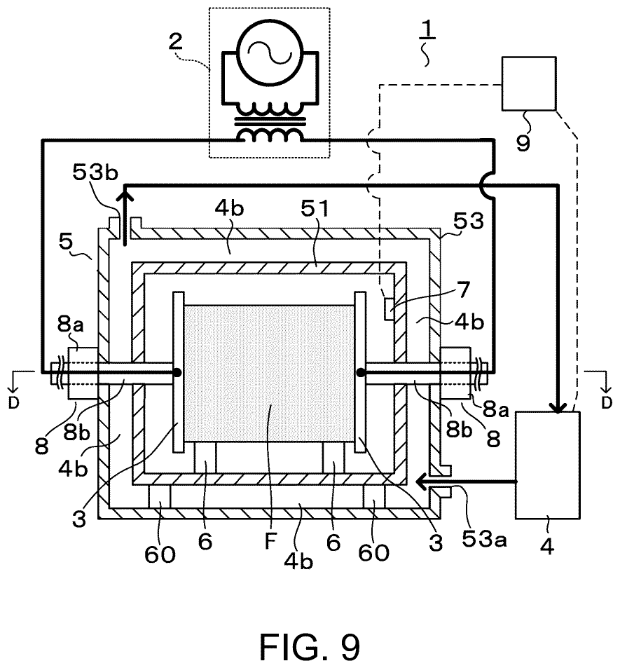

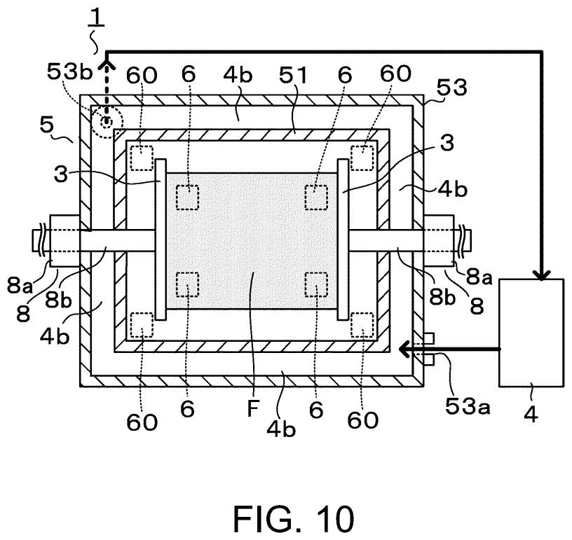

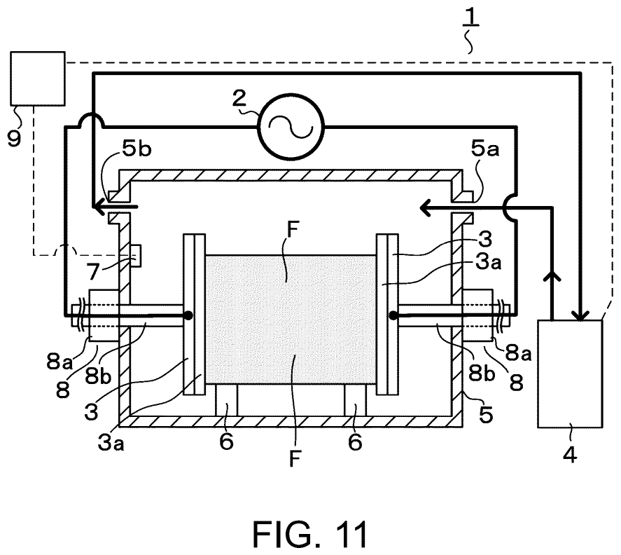

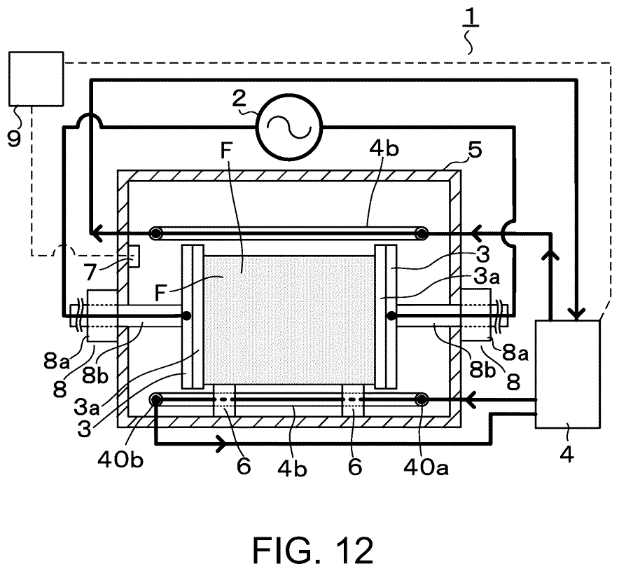

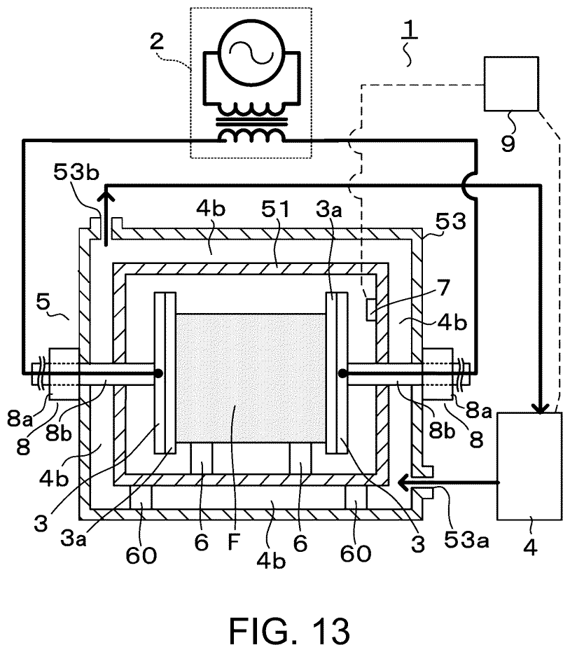

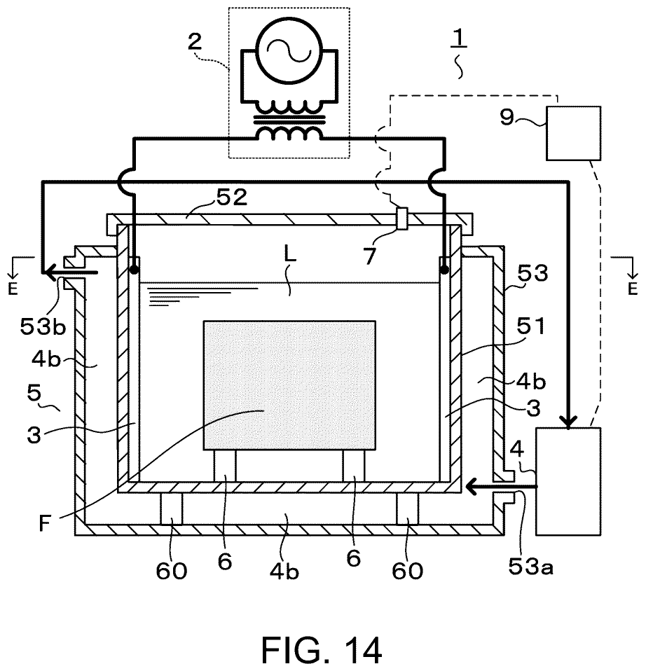

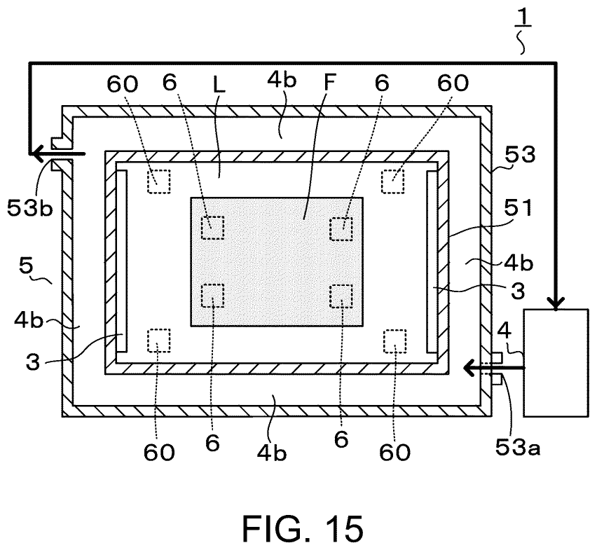

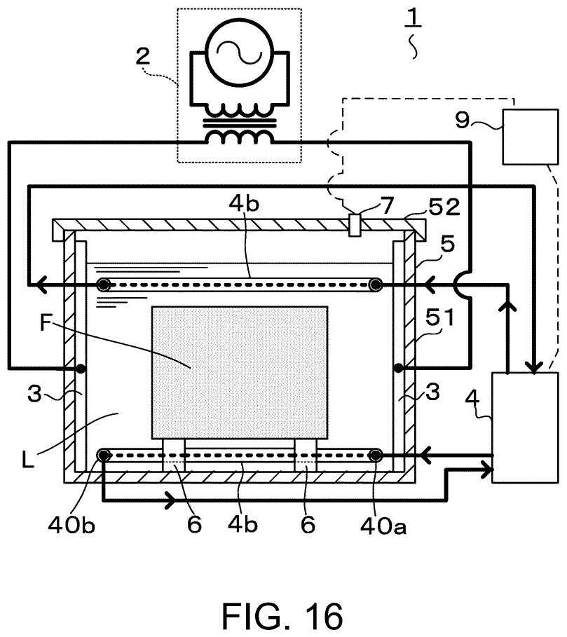

In the following, a thawing device of the invention is described with the embodiment schematically shown in FIGS. 1 to 16. FIG. 1 is a schematic view illustrating an embodiment of a thawing device of the invention. FIG. 2 is a schematic cross-sectional view taken along signs of A-A of FIG. 1. FIG. 3 is a schematic view illustrating another embodiment of a thawing device of the invention. FIG. 4 is a schematic cross-sectional view taken along signs B-B of FIG. 3. FIG. 5 is a schematic view illustrating another embodiment of a thawing device of the invention. FIG. 6 is a schematic cross-sectional view taken along signs C-C of FIG. 5. FIG. 7 is a schematic view illustrating an embodiment of a thawing device of the invention. FIG. 8 is a schematic view illustrating another embodiment of a thawing device of the invention. FIG. 9 is a schematic view illustrating another embodiment of a thawing device of the invention. FIG. 10 is a schematic cross-sectional view taken along signs D-D of FIG. 9. FIG. 11 is a schematic view illustrating another embodiment of a thawing device of the invention. FIG. 12 is a schematic view illustrating another embodiment of a thawing device of the invention. FIG. 13 is a schematic view illustrating another embodiment of a thawing device of the invention. FIG. 14 is a schematic view illustrating another embodiment of a thawing device of the invention. FIG. 15 is a schematic cross-sectional view taken along signs E-E of FIG. 14. FIG. 16 is a schematic view illustrating another embodiment of a thawing device of the invention.

A thawing device 1 according to the invention includes a power 2 and a pair of electrodes 3 connected with the power 2. The thawing device 1 thaws a frozen food F disposed between the pair of electrodes 3 by conducting power. The thawing device 1 includes a cooling device 4 configured so that the temperature of the periphery of the frozen food F is cooled to a predetermined temperature equal to or higher than the temperature of the frozen food F before thawing and equal to or lower than 0° C. The cooling device 4 is also referred to as a cooler 4. According to a thawing method of the invention, in the thawing method of thawing the frozen food F through electric heating, the frozen food F is thawed through electric heating in a state in which the temperature of the periphery of the frozen food F is set to the predetermined temperature equal to or higher than the temperature of the frozen food F before thawing and equal to or lower than 0° C. Electric heating is also referred to as Joule heating.

The power 2 is connected with the pair of electrodes 3. If the voltage applied to the frozen food F is increased as much as possible, the frozen food F is thawed within a short time. The power 2 is a DC power or an AC power. The power 2 may be an AC power, for example. In the case of AC power, if the frequency of the AC voltage is increased, the impedance of the frozen food F is decreased, and the current flows through easily. Therefore, the thawing efficiency can be facilitated, and the thawing time can be reduced. The frequency of the AC voltage may be 50 Hz or more and 200 kHz or less. The AC power may also be a high frequency power. The AC power may be formed by a DC power and an inverter. The inverter is a device that converts a DC voltage into an AC voltage of a desired frequency and a desired voltage. The AC power includes a transformer, etc., and may be configured to be able to adjust the magnitude of the AC voltage applied to the frozen food F by using the transformer. If a transformer able to transform a voltage within a range of 0V or higher and 400 V or lower is provided, it is possible to set the magnitude of the AC voltage applied to the frozen food F within such range. The DC power or the AC power may include a transformer, such as an insulating transformer, and may be configured as a non-grounded circuit.

The pair of electrodes 3 is connected with the power 2 and heats the frozen food F through electric heating. The frozen food F is disposed between the pair of electrodes 3. The current flowing through at the time of electric heating flows from one of the electrodes 3 to the other of the electrodes 3 through the frozen food F. The pair of electrodes 3 may be plate-shaped, hook-shaped, clip-shaped, etc. The electrode 3 and the other electrode 3 forming the pair of electrodes 3 may have the same shape or shapes different from each other. In the pair of electrodes 3, for example, it may be configured that one of the electrodes 3 is disposed on the left side of the frozen food F, and the other electrode 3 is disposed on the right side. In the pair of electrodes 3, for example, it may also be configured that one of the electrodes 3 is disposed on the front side of the frozen food F, and the other electrode 3 may be disposed on the rear side. In the pair of electrodes 3, for example, it may also be configured that one of the electrodes 3 is disposed on the upper side of the frozen food F, and the other electrode 3 may be disposed on the lower side. The single electrode 3 disposed on the lower side of the frozen food F may also serve as a table for placing the frozen food F. Without being limited to the above, any position relationship can be adopted for the position relationship between the frozen food and the pair of electrodes 3 as long as the frozen food F is disposed between the pair of electrodes 3.

For example, the frozen food F and the pair of electrodes 3 are electrically conductive according to a configuration as follows. The frozen food F and the pair of electrodes 3 may be electrically conductive through direct contact. In order to increase the contact area between the pair of electrodes 3 and the frozen food F whose surface is uneven, the frozen food F and the pair of electrodes 3 may be electrically conductive through connection members 3a sandwiched between the frozen food F and the pair of electrodes 3 and having an electrically conductive property as well as a flexible property. In order to increase the contact area between the pair of electrodes 3 and the frozen food F whose surface is uneven, the frozen food F and the pair of electrodes 3 may be electrically conductive via a liquid L that is electrically conductive between the pair of electrodes 3. Furthermore, the frozen food F and the pair of electrodes 3 may be electrically conductive by immersing the entire frozen food F into the liquid L that is electrically conductive and stored in an insulated container, etc., in a state in which the frozen food F and the pair electrodes 3 are in direct contact or a state in which the frozen food F and the pair electrodes 3 sandwich the connection members 3a. The connection member 3a that are electrically conductive and the liquid L that is electrically conductive exhibit an electrical conductivity necessary to make the frozen food F and the pair of electrodes 3 electrically conductive to electrically heat the frozen food F. It is noted that “immerse” refers to a state in which a portion or the entirety of an object is put into a liquid.

The connection members 3a that are electrically conductive and flexible are installed to surfaces of the pair of electrodes 3 facing the frozen food F. The connection members 3a are formed by a material that contacts the frozen food F to make the frozen food F and the pair of electrodes 3 electrically conductive and have a cold resistant temperature lower than the temperature of the frozen food F before thawing. The cold resistant temperature is the lowest temperature at which the connection portion 3a is able to maintain the desired flexibility. For example, the connection member 3a is formed by a porous material that is flexible and water-absorbent and the liquid L permeated into the porous material and having an electrically conductive property. The porous material is formed by a material whose cold resistant temperature is lower than the temperature of the frozen food F before thawing. The porous material is, for example, a foam. The foam may be formed continuous bubbles. The continuous bubbles indicate that bubbles are connected with one another, and allow water absorption and power conduction of the liquid L that is electrically conductive. The foam, for example, is a sponge in which continuous bubbles are formed. The liquid L that is electrically conductive is a liquid that makes the frozen food F and the pair of electrodes 3 electrically conductive and has a freezing point lower than the temperature of the frozen food F before thawing. This is to prevent the liquid L that is electrically conductive from being frozen. If the temperature of the frozen food F before thawing is −20° C., for example, an alcoholic brine with a freezing point of −30° C., for example, can be adopted as the liquid L that is electrically conductive. Regarding the connection member 3a, other components and configurations may be adopted, as long as such components and configurations are electrically conductive and flexible.

In addition, in the state in which the pair of electrodes 3 are disposed to be separated from the frozen food F, by immersing at least a portion of the pair of electrodes 3 and the entire frozen food F in the liquid L that is electrically conductive and stored in an insulated container, etc., the pair of electrodes 3 and the frozen food F can also be electrically conductive. In addition, as described above, in the state in which the frozen food F and the pair of electrodes 3 are in direct contact or the state in which the connection members 3a are sandwiched between the frozen food F and the pair of electrodes 3, the entire frozen food F may also be immersed in the liquid L that is electrically conductive and stored in an insulated container, etc., to be electrically conductive. As described above, the liquid L that is electrically conductive is a liquid that makes the frozen food F and the pair of electrodes 3 electrically conductive and has a freezing point lower than the temperature of the frozen food F before thawing. This is to prevent the liquid L that is electrically conductive from being frozen. If the temperature of the frozen food F before thawing is −20° C., for example, an alcoholic brine with a freezing point of −30° C., for example, can be adopted as the liquid L that is electrically conductive. It is noted that, in the case where the entire frozen food F is immersed into the liquid L that is electrically conductive as in each of the above states, the cooling device 4 cools the liquid L that is electrically conductive. The case of cooling the liquid L that is electrically conductive will be described afterwards.

In the case where the entire frozen food F is immersed in the liquid L that is electrically conductive as in each of the above states, the liquid L that is electrically conductive may be a liquid with an electrical conductivity equal to or lower than the frozen food F, and may also be a liquid with an electrical conductivity lower than the frozen food F. In the case where the entire frozen food F is immersed in the liquid L that is electrically conductive as in each of the above states, the liquid L that is electrically conductive, for example, may be a liquid with an electrical conductivity equal to or lower than the frozen food before thawing, and may also be a liquid with an electrical conductivity lower than the frozen food F before thawing. Accordingly, the situation in which a greater amount of current flows through the liquid L that is electrically conductive than the frozen food F for the reason that the electrical conductivity of the liquid L that is electrically conductive for immersing the frozen food F is higher than the electrical conductivity of the frozen food F can be suppressed. Accordingly, the situation in which the thawing time is increased, for example, due to a greater amount of current flowing through the liquid L that is electrically conductive than the frozen food F can be suppressed.

The cooling device 4 cools the temperature of the periphery of the frozen food F to a predetermined temperature equal to or higher than the temperature of the frozen food F before thawing and equal to or lower than 0° C. The predetermined temperature, for example, may be one predetermined temperature within the range of being equal to or higher than the frozen food F before thawing and equal to or lower than 0° C. in the middle of thawing through electric heating. If the temperature of the frozen food F before thawing is −20° C., for example, the cooling device 4 may maintain the predetermined temperature at −20° C., at −15° C., at −10° C., at −5° C., or at 0° C. for example, in the middle of thawing through electric heating. The predetermined temperature is equal to or higher than the frozen food F before thawing and equal to or lower than 0° C., and may be set to be equal to or lower than a temperature at which the frozen food F is desired to be thawed, that is, set to be equal to or lower than a desired thawing temperature. The frozen food F such as meat, poultry, seafood, etc., exhibits a hardness that can be cut by a kitchen knife even at a temperature equal to or higher than −5° C. and equal to or lower than 0° C. For example, if the temperature of the frozen food F before thawing is −20° C., and the desired thawing temperature is −5° C., the predetermined temperature may be set to be equal to or higher than −20° C. and equal to or lower than −5° C.

For example, as shown in FIGS. 1 and 2, the cooling device 4 directly supplies cool air cooled to the predetermined temperature equal to or higher than the temperature of the frozen food F before thawing and equal to or lower than 0° C. from cool air outlets 4a disposed on the periphery of the frozen food F to the periphery of the frozen food F. In the cooling device 4, various cooling means can be adopted. For example, the cooling device 4 may adopt a conventional compression means as described in the following, and may be configured to supply, from the cool air outlet 4a, the cool air cooled by making use of the heat absorption of an evaporator (not shown) from the periphery. The cooling device 4 may also simply supply cool air. In addition, the cooling device 4 may also be provided with a cool air collection port (not shown), and configured so that the cool air collected from the cool air collection port is cooled and then supplied from the cool air outlets 4a again.

The cool air outlets 4a are disposed in the vicinity of the surfaces of the frozen food F excluding the portions where the surfaces of the frozen food F contact the pair of electrodes 3. In the case where the frozen food F and the pair of electrodes 3 are connected by the connection members 3a, the cool air outlets 4a may be disposed in the vicinity of the surfaces of the frozen food F excluding the portions where the surfaces of the frozen food F contact the connection members 3a. At this time, the cool air outlets 4a may also be disposed to blow cool air toward the surfaces of the frozen food F excluding the portions where the connection members 3a contact the surfaces of the frozen food F.

In addition, further to the configuration above, the cool air outlets 4a may also be disposed in the vicinity of surfaces on the side opposite to the surfaces of the pair of electrodes 3 that contact the frozen food F or the connection members 3a. The cool air outlets 4a disposed in the vicinity of the surfaces on the side opposite to the surfaces of the pair of electrodes 3 that contact the frozen food F or the connection members 3a may also be disposed to blow cool air toward the surfaces on the side opposite to the surfaces of the pair of electrodes 3 that contact the frozen food F or the connection members 3a.

In addition, for example, as shown in FIGS. 3 and 4, the cooling device 4 includes cooling members 4b disposed on the periphery of the frozen food F. The cooling members 4b cool the temperature of the periphery of the frozen food F to the predetermined temperature equal to or higher than the temperature of the frozen food F before thawing and equal to or lower than 0° C. For example, the cooling device 4 cools the cooling member 4b and the periphery of the cooling member 4b by circulating a cooling medium through the cooling members 4b. The cooling device 4 may also cool the cooling members 4b by using other configurations and means.

For example, the cooling device 4 may also adopt a conventional compression means. The compression-type cooling device 4 includes a compressor (not shown), a condenser (not shown), a decompresser (not shown), and an evaporator. Here, the evaporator is the cooling members 4b provided in the cooling device 4. The cooling medium flows through the compressor, the condenser, the decompresser in order and returns to the compressor again repetitively. The compressor compresses the cooling medium transmitted from the cooling member 4b and turns the cooling medium into a high-temperature, high-pressure gas. The condenser dissipates the heat of the cooling medium transmitted from the compressor and turns the cooling medium into a moderate-temperature, high-pressure liquid. The decompresser decompresses the pressure of the cooling medium delivered from the condenser, and turns the cooling medium into a low-temperature and low-pressure liquid. The cooling member 4b turns the cooling medium delivered from the decompresser into a low-temperature, low-pressure gas by evaporating the cooling medium inside. At the time of vaporizing the cooling medium in the cooling member 4b, the cooling member 4b and the periphery of the cooling member 4b can be cooled by absorbing the heat in the periphery of the cooling member 4b. The cooling medium in the cooling member 4b returns to the compressor again.

In addition, the cooling device 4 of the compressor type may also include the cooling members 4b and the evaporator separately. At this time, a primary cooling medium circulates through the compressor, the condenser, the decompresser, and the evaporator. At the time of vaporizing the primary cooling medium in the evaporator, a secondary cooling medium is cooled by using the absorption of heat in the periphery of the evaporator. The secondary cooling medium cooled by passing through the periphery of the evaporator is circulated between the cooling device 4 and the cooling members 4b. At this time, the secondary cooling medium is a cooling medium that cools the cooling members 4b and the periphery of the cooling members 4b. The secondary cooling medium is a gas or a liquid able to flow even if the secondary cooling medium is cooled to a desired temperature.

The cooling member 4b is formed by an internal space, a supply port 40a supplying the cooling medium to the internal space, and a discharge port 40b discharging the cooling medium from the internal space. The cooling device 4 is connected with the support port 40a and the discharge port 40b of the cooling member 4b, and, on the one hand, supplies the cooling medium into the cooling member 4b through the support port 40a and, on the other hand, collects the cooling medium discharged through the discharge port 40b from the inside of the cooling member 4b. In this way, the cooling device 4 is arranged to supply the cooling medium collected from the cooling member 4b to the cooling member 4b again, and circulate the cooling medium in the cooling member 4b. A pipe in which one end may be used as the supply port 40a and the other end may be used as the discharge port 40b may be adopted as the cooling member 4b.

In the embodiment shown in FIGS. 3 and 4, since the frozen food F and the pair of electrodes 3 are connected by the connection members 3a, the cooling members 4b may be disposed in the vicinity of the surfaces of the frozen food F excluding the portions where the surfaces of the frozen food F contact the connection members 3a. In the case where the frozen food F directly contacts the pair of electrodes 3, the cooling members 4b may be disposed in the vicinity of the surfaces of the frozen food F excluding the portions where the surfaces of the frozen food F directly contact the pair of electrodes 3. In addition, further to the configuration above, the cooling members 4b may also be disposed in the vicinity of surfaces on the side opposite to the surfaces of the pair of electrodes 3 that contact the frozen food F or the connection members 3a.

In addition, for example, as shown in FIGS. 5 and 6, the cooling members 4b may also directly contact the surfaces of the frozen food F excluding the portions where the surfaces of the frozen food F directly contact the pair of electrodes 3. At this time, in the cooling member 4b, at least the portion contacting the frozen food F is formed by an insulation material. In addition, in the case where the frozen food F and the pair of electrodes 3 are connected by the connection members 3a, the cooling members 4b may also directly contact the surfaces of the frozen food F excluding the portions where the surface of frozen food F contact connection members 3a. At this time as well, in the cooling member 4b, at least the portion contacting the connection member 3a is formed by an insulation material. In addition, further to the configuration above, the cooling members 4b may also be installed to the surfaces on the side opposite to the surfaces of the pair of electrodes 3 that contact the frozen food F or the connection members 3a. At this time as well, in the cooling members 4b, at least the portions contacting the pair of electrodes 3 are formed by an insulation material.

The thawing device 1 of the invention may also include a temperature detection device and a control device not shown in FIGS. 1 to 6. The temperature detection device is also referred to as a temperature sensor. The control device is also referred to as a controller. The temperature detection device detects the temperature of the periphery of the frozen food, and outputs the detected temperature. The control device is at least connected with the cooling device 4, and controls the cooling device 4 so that the temperature of the periphery of the frozen food F is cooled to the predetermined temperature. For example, the control device is connected with the cooling device 4 and the temperature detection device, receives the detected temperature output from the temperature detection device, and controls the cooling device 4 so that the temperature of the periphery of the frozen food F is cooled to the predetermined temperature. The control device may also be connected with the power 2 and an electrode movement device 8 to be configured to control the entirety of the thawing device 1.

More specifically, the thawing device 1 of the invention will be described with some embodiments as examples.

The thawing device 1 shown in FIG. 7 includes the power 2, the pair of electrodes 3, the cooling device 4, the thawing chamber 5, a support stage 6, a temperature detection device 7, the electrode movement device 8, and a control device 9. The temperature detection device 7 is also referred to as a temperature sensor 7. The control device 9 is also referred to as a controller 9.

The thawing chamber 5 at least accommodates the frozen food F and the pair of electrodes 3. In addition, a gas supply port 5a and a gas discharge port 5b in communication with each other are formed in the thawing chamber 5, and the thawing chamber 5 is filled with a gas. The gas is, for example, air. By providing the thawing chamber 5, the cooling efficiency using the cooling device 4 can be facilitated. For example, in the thawing chamber 5, the cooling efficiency by using the cooling device 4 can be facilitated by adopting a heat insulation material in a component forming the interior of the thawing chamber 5. As another example, in the thawing chamber 5, by covering the periphery with a heat insulation material, the cooling efficiency using the cooling device 4 can be facilitated. A portion of the thawing chamber 5 in which insulation is required or the entire thawing chamber 5 may be configured as appropriate by using an insulation material. The thawing chamber 5 has an opening/closing door (not shown) on a side surface for taking the frozen food F into and out of the thawing chamber 5. A portion of the opening/closing door in which insulation is required or the entire opening/closing door may be configured as appropriate by using an insulation material. The frozen food F accommodated in the thawing chamber 5 is placed on the support stage 6 in the thawing chamber 5. In the support stage 6, at least the portion contacting the frozen food F is formed by an insulation material. The support stage 6 may be entirely formed by an insulation material. The support stage 6 may be formed by a table (not shown) on which the frozen food F is located, and a leg part (not shown) supporting the table.

The pair of electrodes 3 directly contacts the frozen food F to be electrically conductive. The pair of electrodes 3 can be moved within the thawing chamber 5 by the electrode movement device 8 so as to be able to contact/be separated from the frozen food F. For example, the electrode movement device 8 is formed by a driving source 8a of various types, such as a motor or a hydraulic cylinder, and a movement member 8b to which the electrode 3 is installed and which is moved by the driving source 8a. The electrode movement device 8 may also be configured to drive the movement member 8b by using manpower without using the driving source 8a. A seal member (not shown) may seal between the through hole of the thawing device 5 and the movement member 8b penetrating through the through hole and movably installed.

The temperature detection device 7 detects the temperature in the thawing chamber 5 and outputs the detected temperature.

The control device 9 is at least connected with the cooling device 4 and controls the cooling device 4 so as to cool the temperature in the thawing chamber 5 to the predetermined temperature to be described afterwards. For example, the control device 9 is connected with the temperature detection device 7 and the cooling device 4. In addition, the control device 9 may also be connected with an input device (not shown) inputting a set temperature. The set temperature is the predetermined temperature to be described afterwards. The control device 9 receives the detected temperature output from the temperature detection device 7, and controls the cooling device 4 to cool the temperature in the thawing chamber 5 to the set temperature. The control device 9 may also be connected with the power 2 and the electrode movement device 8 to control the entirety of the thawing device 1.

The cooling device 4 supplies the cool air from the gas supply port 5a into the thawing chamber 5 in order to cool the temperature of the gas in the thawing chamber 5 to the predetermined temperature that is equal to or higher than the temperature of the frozen food F before thawing and equal to or lower than 0° C. At this time, the gas overflowing from the thawing chamber 5 is discharged from the gas discharge port 5b. If it is configured that the cooling device 4 is connected with the gas supply port 5a and the gas discharge port 5b and cools the temperature of the gas in the thawing chamber 5 to the predetermined temperature equal to or higher than the frozen food F before thawing and 0° C. or lower while circulating the gas therebetween in the thawing chamber 5, the cooling efficiency may be facilitated. In addition, the gas supply port 5a may also be disposed to provide a pipe (not shown) in the thawing chamber 5 to supply cool air to the vicinity of the surface of the frozen food F. In the cooling device 4, various cooling means can be adopted. For example, the cooling device 4 may adopt the conventional compression type as described above, and may be configured to supply the cool air cooled by making use of the heat absorption of the evaporator from the periphery from the gas supply port 5a into the thawing chamber 5. In addition, it may also be configured that the cool air collected from the gas discharge port 5b is cooled again by passing through the periphery of the evaporator and then supplied into the thawing chamber 5 from the gas supply port 5a.

The thawing device 1 shown in FIG. 8 illustrates a configuration different from the cooling device 4 shown in FIG. 7. The cooling device 4 includes cooling members 4b installed to positions not in contact with the frozen food F and the pair of electrodes 3 in the thawing chamber 5. The cooling device 4 cools the cooling members 4b by circulating the cooling medium in the cooling members 4b inside the thawing chamber 5, and cools the temperature of the gas in the thawing chamber 5 to the predetermined temperature equal to or higher than the temperature of the frozen food F before thawing and equal to or lower than 0° C. In the cooling device 4, various cooling means can be adopted. For example, the cooling device 4 may also adopt a conventional compression means.

For example, the cooling members 4b may be installed to a surface formed in the thawing chamber 5 inside the thawing chamber 5. The interior of the thawing chamber 5 is cooled by the cooling chambers 4b provided inside the thawing chamber 5. In addition, the cooling members 4b may also be disposed in the vicinity of the surface of the frozen food F. In addition, the cooling members 4b may also contact directly the surface of the frozen food F. In the case where the cooling members 4b contact the surface of the frozen food F, at least the portion of the cooling member 4b contacting the frozen food F is formed by an insulation material.

In addition, the cooling members 4b may also be built in necessary places among the sidewall part, the bottom surface part, and the ceiling part forming the thawing chamber 5. The cooling members 4b may have a double structure in the necessary places among the sidewall part, the bottom surface part, and the ceiling part forming the thawing chamber 5, and may be configured to form a space for circulating the cooling medium between the double structure. For example, as shown in FIGS. 9 and 10 to be described afterwards, the cooling members 4b may be configured so that a container 51 formed in the thawing chamber 5 is accommodated in a housing 53 of the thawing chamber 5 to form a space for circulating the cooling medium between the inner side of the housing 53 and the outer side of the container 51. The space for circulating the cooling medium may also be formed by a cooling pipe. That is, the substantial interior of the thawing chamber 5 may also be cooled through the heat conduction from the cooling members 4b provided outside.

The thawing device 1 shown in FIGS. 9 and 10 illustrates a configuration different from the thawing chamber 5 and the cooling device 4 shown in FIGS. 7 and 8. In addition, the power 2 shown in FIG. 9 illustrates the case of an AC power formed by a non-grounded circuit including a transformer, such as an insulating transformer.

The thawing chamber 5 at least accommodates the frozen food F and the pair of electrodes 3. The thawing chamber 5, for example, is formed by the container 51 accommodating the frozen food F and the pair of electrodes 3 and the housing 53 accommodating the container 51. At this time, a space for circulating the cooling medium is formed between the surface on the outer side of the container 51 and the surface on the inner side of the housing 53. The internal space of the container 51 is substantially the interior of the thawing chamber 5. The thawing chamber 5, for example, has an opening/closing door (not shown) on the upper or side surface for taking the frozen food F into and out of the thawing chamber 5.

In the housing 53, a supply port 53a for supplying the cooling medium to the space formed with the container 51 that is accommodated and a discharge port 53b for discharging the cooling medium from the space are formed. The supply port 53a and the discharge port 53b are respectively connected with the cooling device 4 to be described afterwards. Therefore, the cooling members 4b are formed by a space formed between the surface on the outer side of the container 51 and the surface on the inner side of the housing 53 and the supply port 53a and the discharge port 53b formed in the housing 53. A portion of the housing 53 in which insulation is required or the entire housing 53 may be configured as appropriate by using an insulation material. The housing 53 may also include an insulation material for facilitating the cooling efficiency by using the cooling medium.

The container 51, for example, is disposed on the support stage 60 in the housing 53. A space where the cooling medium can circulate can also be formed between a bottom surface on the outer side of the container 51 and a bottom surface on the inner side of the housing 53 by using the support stage 60. In place of the support stage 60, the container 51 may also include a leg part (not shown) extending downward from the bottom surface. A portion of the support stage 60 or the leg part in which insulation is required or the entire support stage 60 or leg part may be configured as appropriate by using an insulation material. It is noted that, the means for providing the container 51 in the housing 53 is not limited to the container 60. Other means can also be adopted as long as a space can be formed between the surface on the outer side of the container 51 and the surface on the inner side of the housing 53.

The container 51 at least accommodates the pair of electrodes 3 and the frozen food F. In addition, the container 51 is filled with gas. The gas is, for example, air. In the container 51, the frozen food F can be taken in and out by opening the opening/closing door (not shown). A portion of the container 51 in which insulation is required or the entire container 51 may be configured as appropriate by using an insulation material. The container 51 is formed by using a material having a thermal conductivity able to cool the inside of the container 51 by using the cooling medium circulating around the periphery. The frozen food F is placed on the support stage 6 in the container 51. In the support stage 6, at least the portion contacting the frozen food F is formed by an insulation material. The support stage 6 may be entirely formed by an insulation material. The support stage 6 may be formed by a table (not shown) on which the frozen food F is located, and a leg part (not shown) supporting the table.

By closing the opening/closing door (not shown), the internal space of the container 51 becomes a closed space. In addition, by closing the opening/closing door, the space for circulating the cooling medium becomes a closed space able to only supply the cooling medium from the supply port 53a and discharge the cooling medium from the discharge port 53b. The opening/closing door can be configured as being able to circulate the cooling medium inside. The opening/closing door, for example, may also include the cooling member 4b. At this time, in the opening/closing door, the surface exposed to the interior of the container 51 may also be formed by a material having a thermal conductivity able to cool the inside of the container 51 by using the cooling medium. In addition, in order to facilitate the cooling efficiency by using the cooling medium, the opening/closing door may also include an insulation material on the surface exposed to the outside of the housing 53. In addition, a portion of the opening/closing door in which insulation is required or the entire opening/closing door may be configured as appropriate by using an insulation material.

The pair of electrodes 3 directly contacts the frozen food F to be electrically conductive. The pair of electrodes 3 can be moved within the container 51 by the electrode movement device 8 so as to be able to contact/be separated from the frozen food F. For example, the electrode movement device 8 is formed by a driving source 8a of various types, such as a motor or a hydraulic cylinder, and a movement member 8b to which the electrode 3 is installed and which is moved by the driving source 8a. The electrode movement device 8 may also be configured to drive the movement member 8b by using manpower without using the driving source 8a. Seal members (not shown) may also respectively seal between the through holes respectively formed in the housing 53 and the container 51 forming the thawing chamber 5 and the movement members 8b movably installed through the through holes.

The temperature detection device 7 detects the temperature in the thawing chamber 5 and outputs the detected temperature. For example, the temperature detection device 7 detects the temperature in the container 51 substantially forming the interior of the thawing chamber 5 and outputs the detected temperature.

The control device 9 is at least connected with the cooling device 4 and controls the cooling device 4 so as to cool the temperature in the thawing chamber 5 to the predetermined temperature. For example, the control device 9 is connected with the temperature detection device 7 and the cooling device 4. In addition, the control device 9 may also be connected with an input device (not shown) inputting a set temperature. The set temperature is the predetermined temperature to be described afterwards. The control device 9 receives the detected temperature output from the temperature detection device 7, and controls the cooling device 4 to cool the temperature in the container 51 substantially forming the interior of the thawing chamber 5 to the set temperature. The control device 9 may also be connected with the power 2 and the electrode movement device 8 to control the entirety of the thawing device 1.

The cooling device 4 is respectively connected with the supply port 53a and the discharge port 53b of the housing 53, supplies the cooling medium to the space formed between the surface on the outer side of the container 51 and the surface on the inner side of the housing 53 through the supply port 53a, and accommodates the cooling medium discharged from the space through the discharge port 53b. By circulating the cooling medium in the space formed between the surface on the outer side of the container 51 and the surface on the inner side of the housing 53, the cooling device 4 cools the inside of the container 51 from the periphery of the container 51, and cools the temperature of the inside of the container 51 to the predetermined temperature equal to or higher than the temperature of the frozen food F before thawing and equal to or lower than 0° C. In the cooling device 4, various cooling means can be adopted. For example, the cooling device 4 may also adopt a conventional compression means.

The thawing device 1 shown in FIG. 11 illustrates a configuration of a case where the connection members 3a are installed to the pair of electrodes 3 shown in FIG. 7 to make the frozen food F and the pair of electrodes 3 electrically conductive.

The thawing device 1 shown in FIG. 12 illustrates a configuration of a case where the connection members 3a are installed to the pair of electrodes 3 shown in FIG. 8 to make the frozen food F and the pair of electrodes 3 electrically conductive.

The thawing device 1 shown in FIG. 13 illustrates a configuration of a case where the connection members 3a are installed to the pair of electrodes 3 shown in FIG. 9 to make the frozen food F and the pair of electrodes 3 electrically conductive.

The thawing device 1 shown in FIGS. 14 and 15 includes the power 2, the pair of electrodes 3, the cooling device 4, the thawing chamber 5, the support stage 6, the temperature detection device 7, and the control device 9. The power 2 shown in FIG. 14 illustrates the case of an AC power formed by a non-grounded circuit including a transformer, such as an insulating transformer.

The thawing chamber 5 at least accommodates the frozen food F and the pair of electrodes 3 and also accommodates the liquid L that is electrically conductive for immersing the entirety of the frozen food F and at least a portion of the pair of electrodes 3. The thawing chamber 5, for example, is formed by the container 51 accommodating the electrodes 3, the frozen food F and the liquid L, a cover member 52 covering the opening of the upper part of the container 51 and the housing 53 accommodating the container 51 except for the upper part. At this time, a space for circulating the cooling medium is formed between the surface on the outer side of the container 51 and the surface on the inner side of the housing 53. In addition, the opening of the upper part of the housing 53 is formed in a size blocked through fitting of the upper part of the container 51. In addition, the internal space of the container 51 is substantially the interior of the thawing chamber 5. By closing the opening of the upper part of the container 51 by the cover member 52, the interior of the thawing chamber 5 becomes a closed space.

In the housing 53, the supply port 53a for supplying the cooling medium to the space formed with the container 51 that is accommodated and the discharge port 53b for discharging the cooling medium from the space are formed. The supply port 53a and the discharge port 53b are respectively connected with the cooling device 4 to be described afterwards. Therefore, the cooling members 4b are formed by a space formed between the surface on the outer side of the container 51 and the surface on the inner side of the housing 53 and the supply port 53a and the discharge port 53b formed in the housing 53. A portion of the housing 53 in which insulation is required or the entire housing 53 may be configured as appropriate by using an insulation material. The housing 53 may also include an insulation material for facilitating the cooling efficiency by using the cooling medium.

The container 51, for example, is disposed on the support stage 60 in the housing 53. A space where the cooling medium can circulate can also be formed between the bottom surface on the outer side of the container 51 and the bottom surface on the inner side of the housing 53 by using the support stage 60. In place of the support stage 60, the container 51 may also include a leg part (not shown) extending downward from the bottom surface. A portion of the support stage 60 or the leg part in which insulation is required or the entire support stage 60 or leg part may be configured as appropriate by using an insulation material. It is noted that, the means for providing the container 51 in the housing 53 is not limited to the container 60. Other means can also be adopted as long as a space can be formed between the surface on the outer side of the container 51 and the surface on the inner side of the housing 53.

The container 51 at least accommodates the frozen food F and the pair of electrodes 3 and accommodates the liquid L that is electrically conductive and supplied until the entirety of the frozen food F and at least a portion of the pair of electrodes 3 are immersed. In the container 51, the frozen food F can be taken in and out from the opening on the top. In the container 51, a portion that contacts a place conducted with power, such as a portion contacting the pair of electrodes 3 and the liquid L that is electrically conductive is formed by an insulation material, or the entirety is formed by an insulation material. The container 51 is formed by using a material having a thermal conductivity able to cool the inside of the container 51 by using the cooling medium circulating around the periphery. The frozen food F is placed on the support stage 6 in the container 51. In the support stage 6, a portion that contacts a place conducted with power, such as a portion contacting the surface of the frozen food F and a portion contacting the liquid L that is electrically conductive, is formed by an insulation material, or the entirety is formed by an insulation material.

The cover member 52 opens and closes the opening of the upper part of the container 51. The cover member 52 may also include an insulation material. In addition, the cover member 52 may also include the cooling member 4b. A portion of the cover member 52 in which insulation is required or the cover member 52 may be configured as appropriate by using an insulation material.

As described above, the liquid L that is electrically conductive is a liquid that makes the frozen food F and the pair of electrodes 3 electrically conductive and has a freezing point lower than the temperature of the frozen food F before thawing. If the temperature of the frozen food F before thawing is −20° C., for example, an alcoholic brine with a freezing point of −30° C., for example, can be adopted as the liquid L that is electrically conductive. In addition, the liquid L that is electrically conductive may be a liquid with an electrical conductivity equal to or lower than the frozen food F, and may also be a liquid with an electrical conductivity lower than the frozen food F. In addition, the liquid L that is electrically conductive, for example, may be a liquid with an electrical conductivity equal to or lower than the frozen food F before thawing, and may also be a liquid with an electrical conductivity lower than the frozen food F before thawing.

The pair of electrodes 3 are disposed to be separated from the frozen food F. For example, as shown in FIGS. 14 and 15, the pair of electrodes 3 are installed on the inner wall of the container 51 to face each other. The frozen food F is placed at a position not contacting the pair of electrodes 3 between the pair of electrodes 3. While omitted in the drawings, the thawing device 1 may also be configured so that, in the state in which the frozen food F and the pair of electrodes 3 are in direct contact or the state in which the connection members 3a are sandwiched between the frozen food F and the pair of electrodes 3 as described above, the entire frozen food F is immersed in the liquid L that is electrically conductive and stored in the container 51 to be electrically conductive.

The temperature detection device 7 detects the temperature of the liquid L that is electrically conductive in the thawing chamber 5, and outputs the detected temperature. For example, the temperature detection device 7 detects the temperature of the liquid L that is electrically conductive and accommodated in the container 51 forming the substantially interior of the thawing chamber 5, and outputs the detected temperature. In the case of detecting the temperature of the liquid L that is electrically conductive through direct contact, the portion of the temperature detection device 7 contacting the liquid L that is electrically conductive is formed by an insulation material. In addition, the temperature detection device 7 may also use a non-contact temperature sensor. The temperature detection device 7 of FIG. 14 is formed by a non-contact temperature sensor installed above the liquid L that is electrically conductive in the container 51.

The control device 9 is at least connected with the cooling device 4 and controls the cooling device 4 so as to cool the temperature of the liquid L that is electrically conductive and accommodated in the thawing chamber 5 to the predetermined temperature. For example, the control device 9 is connected with the temperature detection device 7 and the cooling device 4. In addition, the control device 9 may also be connected with an input device (not shown) inputting a set temperature. The set temperature is the predetermined temperature to be described afterwards. The control device 9 receives the detected temperature output from the temperature detection device 7, and controls the cooling device 4 to cool the temperature of the liquid L that is electrically conductive and accommodated in the container 51 substantially forming the interior of the thawing chamber 5 to the set temperature. The control device 9 may also be connected with the power 2 and configured to control the entirety of the thawing device 1.

The cooling device 4 is respectively connected with the supply port 53a and the discharge port 53b of the housing 53, supplies the cooling medium to the space formed between the surface on the outer side of the container 51 and the surface on the inner side of the housing 53 through the supply port 53a, and accommodates the cooling medium discharged from the space through the discharge port 53b. By circulating the cooling medium in the space formed between the surface on the outer side of the container 51 and the surface on the inner side of the housing 53, the cooling device 4 cools the inside of the container 51 from the periphery of the container 51, and cools the temperature of the liquid L that is electrically conductive in the container 51 to the predetermined temperature equal to or higher than the temperature of the frozen food F before thawing and equal to or lower than 0° C. In the cooling device 4, various cooling means can be adopted. For example, the cooling device 4 may also adopt a conventional compression means.

The thawing device 1 shown in FIG. 16 includes the power 2, the pair of electrodes 3, the cooling device 4, the thawing chamber 5, the support stage 6, the temperature detection device 7, and the control device 9. The power 2 shown in FIG. 16 illustrates the case of an AC power formed by a non-grounded circuit including a transformer, such as an insulating transformer.

The thawing chamber 5 at least accommodates the frozen food F and the pair of electrodes 3 and also accommodates the liquid L that is electrically conductive for immersing the entirety of the frozen food F and at least a portion of the pair of electrodes 3. The thawing chamber 5, for example, is formed by the container 51 accommodating the pair of electrodes 3, the frozen food F, and the liquid L and the cover member 52 covering the opening of the upper part of the container 51. The internal space of the container 51 is substantially the interior of the thawing chamber 5.

The container 51 at least accommodates the frozen food F and the pair of electrodes 3 and accommodates the liquid L that is electrically conductive and supplied until the entirety of the frozen food F and at least a portion of the pair of electrodes 3 are immersed. With the opening of the upper part of the container 51, the frozen food F can be taken in and out. In the container 51, a portion that contacts a place conducted with power, such as a portion contacting the pair of electrodes 3 and the liquid L that is electrically conductive is formed by an insulation material, or the entirety is formed by an insulation material. The frozen food F is placed on the support stage 6 in the container 51. In the support stage 6, a portion that contacts a place conducted with power, such as a portion contacting the surface of the frozen food F and a portion contacting the liquid L that is electrically conductive is formed by an insulation material, or the entirety is formed by an insulation material.

The cover member 52 opens and closes the opening of the upper part of the container 51. The cover member 52 may also include an insulation material. The cover member 52 may also include the cooling member 4b. A portion of the cover member 52 in which insulation is required or the entire cover member 52 may be configured as appropriate by using an insulation material.

As described above, the liquid L that is electrically conductive is a liquid that makes the frozen food F and the pair of electrodes 3 electrically conductive and has a freezing point lower than the temperature of the frozen food F before thawing. For example, if the temperature of the frozen food F before thawing is −20° C., an alcoholic brine with a freezing point of −30° C., can be adopted as the liquid L that is electrically conductive. In addition, the liquid L that is electrically conductive may be a liquid with an electrical conductivity equal to or lower than the frozen food F, and may also be a liquid with an electrical conductivity lower than the frozen food F. In addition, the liquid L that is electrically conductive, for example, may be a liquid with an electrical conductivity equal to or lower than the frozen food F before thawing, and may also be a liquid with an electrical conductivity lower than the frozen food F before thawing.

The pair of electrodes 3 are disposed to be separated from the frozen food F. For example, as shown in FIG. 16, the pair of electrodes 3 are installed on the inner wall of the container 51 to face each other. The frozen food F is placed at a position not contacting the pair of electrodes 3 between the pair of electrodes 3. While omitted in the drawings, the thawing device 1 may also be configured so that, in the state in which the frozen food F and the pair of electrodes 3 are in direct contact or the state in which the connection members 3a are sandwiched between the frozen food F and the pair of electrodes 3 as described above, the entire frozen food F is immersed in the liquid L that is electrically conductive and stored in the container 51 to be electrically conductive. When the frozen food F contacts the pair of electrodes 3, due to the unevenness of the surface of the frozen food F, a gap may occur in a portion between the frozen food F and the pair of electrodes 3. When the frozen food F contacts the connection members 3a, due to the unevenness of the surface of the frozen food F, a gap may be present in a portion between the frozen food F and the connection members 3a. The liquid L that is electrically conductive enters the gap, and the portion where the gap is present is also electrically conductive.

The temperature detection device 7 detects the temperature of the liquid L that is electrically conductive in the thawing chamber 5, and outputs the detected temperature. For example, the temperature detection device 7 detects the temperature of the liquid L that is electrically conductive and accommodated in the container 51 forming the substantially interior of the thawing chamber 5, and outputs the detected temperature. In the case of detecting the temperature of the liquid L that is electrically conductive through direct contact, the portion of the temperature detection device 7 contacting the liquid L that is electrically conductive is formed by an insulation material. In addition, the temperature detection device 7 may also use a non-contact temperature sensor. The temperature detection device 7 of FIG. 16 is formed by a non-contact temperature sensor installed above the liquid L that is electrically conductive in the container 51.

The control device 9 is at least connected with the cooling device 4 and controls the cooling device 4 so as to cool the temperature of the liquid L that is electrically conductive and accommodated in the thawing chamber 5 to the predetermined temperature. For example, the control device 9 is connected with the temperature detection device 7 and the cooling device 4. In addition, the control device 9 may also be connected with an input device (not shown) inputting a set temperature. The set temperature is the predetermined temperature to be described afterwards. The control device 9 receives the detected temperature output from the temperature detection device 7, and controls the cooling device 4 to cool the temperature of the liquid L that is electrically conductive and accommodated in the container 51 substantially forming the interior of the thawing chamber 5 to the set temperature. The control device 9 may also be connected with the power 2 and configured to control the entirety of the thawing device 1.

The cooling device 4 includes the cooling members 4b installed to positions not in contact with the frozen food F and the pair of electrodes 3 in the container 51. The cooling member 4b is formed by an internal space, the supply port 40a supplying the cooling medium to the internal space, and the discharge port 40b discharging the cooling medium from the internal space. The cooling device 4 is connected with the support port 40a and the discharge port 40b of the cooling member 4b, and, on the one hand, supplies the cooling medium into the cooling member 4b through the support port 40a and, on the other hand, collects the cooling medium discharged through the discharge port 40b from the inside of the cooling member 4b. In the cooling device 4, various cooling means can be adopted. For example, the cooling device 4 may also adopt a conventional compression means.

The cooling device 4 cools the cooling members 4b by circulating the cooling medium in the cooling members 4b inside the container 51, and cools the temperature of the liquid L that is electrically conductive in the container 51 to the predetermined temperature equal to or higher than the temperature of the frozen food F before thawing and equal to or lower than 0° C.

The cooling members 4b may also be disposed in the vicinity of the surface of the frozen food F excluding the surfaces of the frozen food F facing the pair of electrodes 3. The cooling members 4b may also directly contact the surfaces of the frozen food F excluding the surfaces of the frozen food F facing the pair of electrodes 3.

In the cooling member 4b, a portion contacting the liquid L that is electrically conductive is formed by an insulation material, or the entire cooling member 4b is formed by an insulation material. In the case where the cooling member 4b contacts the surface of the frozen food F, a portion of the cooling member 4b contacting the surface of the frozen food F or a portion of the cooling member 4b contacting the liquid L that is electrically conductive is formed by an insulation material, or the entire cooling member 4b is formed by an insulation material. In the pipe supplying/discharging the cooling medium between the cooling device 4 and the cooling member 4b, a portion contacting the liquid L that is electrically conductive in the container 51 is formed by an insulation material, or the entire pipe is formed by an insulation material.

According to the above, regarding the thawing device 1 and the thawing method of the invention, in the thawing device 1 and the thawing method for thawing the frozen food F through electric heating, the frozen food F can be thawed through electric heating in the state in which the temperature of the periphery of the frozen food F is set to the predetermined temperature equal to or higher than the temperature of the frozen food F before thawing and equal to or lower than 0° C. Accordingly, in the case of thawing the frozen food F through electric heating, the thawing of the surface portion of the frozen food F progresses due to the temperature of the periphery of the frozen food F. Thus, the impedance of the surface portion of the frozen food F is suppressed from becoming smaller than the impedance inside the frozen food F, a greater amount of current is suppressed from flowing through the surface portion whose impedance is smaller than the side, and the temperature of the surface portion is suppressed from increasing more quickly than the inside. Therefore, the thawing device and the thawing method according to the invention can more uniformly and evenly increase the temperature of the entire frozen food F than the conventional art.

In addition, according to the thawing device 1 and the thawing method of the invention, it is possible to more uniformly and evenly increase the temperature of the entire frozen food F to further suppress drip from occurring from the frozen food F at the time of thawing the frozen food F such as meat, poultry or seafood.

As an example, at the time of thawing the frozen food F, which is a chicken thigh with a size of 50 millimeters in length, 50 millimeters in width, and 45 millimeters in height frozen to −15° C., to the thawing temperature of −5° C., the thawing time in the case of natural thawing in the environment where the temperature of the periphery of the frozen food F is 25° C. is 17 minutes, whereas the thawing time in the case of thawing through electric heating under an AC voltage with a voltage of 200 V and a frequency of 60 Hz in the environment where the temperature of the periphery of the frozen food F is −5° C. is 6 minutes. In addition, in natural thawing, the temperature of the outer side of the frozen food becomes higher under the influence of the temperature of the periphery, whereas in the thawing using electric heating, the temperature of the entire frozen food can be increased uniformly and evenly, and drip can be prevented from occurring from the frozen food.

The embodiment was chosen in order to explain the principles of the invention and its practical application. Many modifications and variations are possible in light of the above teachings. It is intended that the scope of the invention be defined by the claims.

What is claimed is:

1. A thawing device, comprising a power and a pair of electrodes connected with the power, and thawing a frozen food disposed between the pair of electrodes through electric heating,
wherein the thawing device comprises a cooling device configured to cool a temperature of a periphery of the frozen food to a predetermined temperature equal to or higher than a temperature of the frozen food before thawing and equal to or lower than 0° C.

2. The thawing device as claimed in claim 1, wherein the pair of electrodes contact the frozen food to be electrically conductive with the frozen food.

3. The thawing device as claimed in claim 1, wherein connection members that are electrically conductive and flexible are installed to surfaces of the pair of electrodes facing the frozen food, and
the connection members contact the frozen food to make the frozen food and the pair of electrodes electrically conductive and a cold resistant temperature of the connection members is lower than the temperature of the frozen food before thawing.

4. The thawing device as claimed in claim 3, wherein the connection member is formed by a porous material that is flexible and water-absorbent and a liquid that is electrically conductive and permeated into the porous material,
a cold resistant temperature of the porous material is lower than the temperature of the frozen food before thawing, and
the liquid that is electrically conductive makes the frozen food and the pair of electrodes electrically conductive and has a freezing point lower than the temperature of the frozen food before thawing.

5. The thawing device as claimed in claim 1, comprising a control device at least connected with the cooling device and controlling the cooling device so as to cool the temperature of the periphery of the frozen food to the predetermined temperature.

6. The thawing device as claimed in claim 1, comprising a thawing chamber at least accommodating the pair of electrodes and the frozen food,
wherein the cooling device is configured to cool an interior of the thawing chamber to the predetermined temperature.

7. The thawing device as claimed in claim 6, wherein the pair of electrodes contact the frozen food to be electrically conductive with the frozen food.

8. The thawing device as claimed in claim 6, wherein connection members that are electrically conductive and flexible are installed to surfaces of the pair of electrodes facing the frozen food, and
the connection members contact the frozen food to make the frozen food and the pair of electrodes electrically conductive and a cold resistant temperature of the connection members is lower than the temperature of the frozen food before thawing.

9. The thawing device as claimed in claim 8, wherein the connection member is formed by a porous material that is flexible and water-absorbent and a liquid that is electrically conductive and permeated into the porous material,
a cold resistant temperature of the porous material is lower than the temperature of the frozen food before thawing, and
the liquid that is electrically conductive makes the frozen food and the pair of electrodes electrically conductive and has a freezing point lower than the temperature of the frozen food before thawing.

10. The thawing device as claimed in claim 6, comprising a control device at least connected with the cooling device and controlling the cooling device so as to cool a temperature of the interior of the thawing chamber to the predetermined temperature.

11. The thawing device as claimed in claim 1, comprising a thawing chamber at least accommodating the pair of electrodes and the frozen food and accommodating a liquid that is electrically conductive for immersing an entirety of the frozen food and at least a portion of the pair of electrodes,
the liquid that is electrically conductive makes the frozen food and the pair of electrodes electrically conductive and has a freezing point lower than the temperature of the frozen food before thawing, and
the cooling device is configured to cool the liquid that is electrically conductive to the predetermined temperature.

12. The thawing device as claimed in claim 11, wherein the pair of electrodes are disposed to be separated from the frozen food.

13. The thawing device as claimed in claim 11, wherein the pair of electrodes contact the frozen food to be electrically conductive with the frozen food.

14. The thawing device as claimed in claim 11, wherein connection members that are electrically conductive and flexible are installed to surfaces of the pair of electrodes facing the frozen food, and
the connection members contact the frozen food to make the pair of electrodes and the frozen food electrically conductive, and a cold resistant temperature of the connection member is lower than the temperature of the frozen food before thawing.

15. The thawing device as claimed in claim 14, wherein the connection member is formed by a porous material that is flexible and water-absorbent and a liquid that is electrically conductive and permeated into the porous material,
a cold resistant temperature of the porous material is lower than the temperature of the frozen food before thawing, and
the liquid that is electrically conductive and permeated into the porous material makes the pair of electrodes and the frozen food electrically conductive.

16. The thawing device as claimed in claim 11, comprising a control device at least connected with the cooling device and controlling the cooling device so as to cool a temperature of the liquid that is electrically conductive accommodated in the thawing chamber to the predetermined temperature.

17. The thawing device as claimed in claim 1, wherein the cooling device comprises cooling members cooled to the predetermined temperature, and
the cooling members are in contact with surfaces of the frozen food excluding surfaces of the frozen food facing the pair of electrodes.

18. A thawing method for thawing a frozen food through electric heating,
wherein the frozen food is thawed through electric heating in a state in which a temperature of a periphery of the frozen food is set to a predetermined temperature equal to or higher than a temperature of the frozen food before thawing and equal to or lower than 0° C.
